(19) United States
(12) Patent Application Publication
(10) Pub. No.: US 2003/0215589 A1
(43) Pub. Date: Nov. 20, 2003

(54) Antimicrobial film structures for use in HVAC

(76) Inventors: Rick Merical, Appleton, WI (US); Chad Mueller, Neenah, WI (US)

Correspondence Address: Joy Ann G. Serauskas, McDermott, Will & Emery, 227 West Monroe Street, Chicago, IL, 60606-5096, US

(21) Appl. No.: 10/151,413

(22) Filed: May 17, 2002

(51) Int. Cl. B32B 1/02

(52) U.S. Cl. 428/35.7; 428/36.9

(57) ABSTRACT

The present invention relates to flexible film structures which can be affixed to flexible air duct and methods of making the film. More specifically, the present invention relates to film structures having at least one layer comprising an antimicrobial agent inorporated in a polymer resin or resin blend. The film structures of the present invention can be single layer polymer films comprising a layer of antimicrobial agent incorporated in a polymer resin or a multiple layer film wherein at least one layer comprises antimicrobial agent incorporated in a polymer resin. The film structures of the present invention can be affixed to the wiremold core of a flexible air duct to retard, reduce, inhibit, or eliminate microbial growth which can occur in the duct.

### FIELD OF INVENTION

The present invention relates to flexible film structures which can be affixed to the wiremold core of a flexible air duct. The flexible film structures of the present invention comprise an antimicrobial agent incorporated in a polymer resin or a polymer resin blend. The flexible film structures of the present invention may be single layer films comprising an antimicrobial agent incorporated in a polymer resin or a polymer resin blend. The flexible film structures of the present invention may also be multiple layer films comprising a layer comprising an antimicrobial agent incorporated in a polymer resin or polymer resin blend and one or more polymer layers wherein said polymer layers may comprise a polymer or a blend of polymers and wherein the layer containing the antimicrobial agent is the skin or outer layer of the film structure. The flexible film may be produced by extrusion or coextrusion technology. The flexible film structures of the present invention may optionally be bonded to a substrate wherein said substrate can be a monopolymeric film, a multiple polymer film, foil or paper. The flexible film structures of the present invention are useful in residential, commercial and industrial air conveying systems to retard, reduce, inhibit, or eliminate the microbial growth which can occur in these systems. The present invention also relates to a method of making the flexible film structures of the present invention.

### BACKGROUND OF THE INVENTION

It is generally known to provide a flexible material that may be used in the fabrication of air ducts in heating, ventilating and air conditioning (HVAC) systems. Flexible air ducts consist primarily of a core of wiremold material, a layer of insulation, and a sleeve or tape to wrap around the insulation and the wiremold core.

These flexible air ducts are that part of the HVAC system which handle the circulation of air through a building on a continual basis. As air moves through the system) it leaves behind certain components, such as dust, dirt, grease or volatile organic matter whose origin may be associated with the various activities that take place within a given building housing the HVAC system. These components then affix themselves to the HVAC equipment, especially the inside surfaces of the flexible air ducts. This accumulation of dust, dirt, grease and volatile organic matter on the inside surfaces of ducts can serve as a breeding ground for various mold, fungus, mildew or bacteria which, if not corrected, may cause health problems. While microbial matter can be found on the inside surface of the air duct, microbial matter is also found in the air which circulates through the duct. Therefore it has become important that this problem of microbial growth in HVAC systems be addressed.

### DESCRIPTION OF THE PRIOR ART

U.S. Pat. No. 5,314,719 to Batdorf teaches HVAC systems having interior surfaces exposed to moist air protected against fungal growth by coating the interior surfaces with an adherent flexible polymer film which includes a fungicidal composition in an amount effective to provide a zone of inhibition against multiple fungal species of at least 1 mm, and which employs active fungicidal ingredients which are substantially non-volatile and non-soluble in water.

U.S. Pat. No. 5,556,699 to Niira teaches an antibiotic film comprising at least one organic polymer film containing antibiotic zeolite, in which the content of the antibiotic zeolite is 10 to 100 mg/m² of the organic polymer film and the thickness of the organic polymer film is not more than 15 microns and an antibiotic laminated film comprises a substrate, at least one side of which is laminated with the aforementioned antibiotic film. These films exhibit excellent antibiotic action although they contain rather small amounts of antibiotic zeolite. Further, the films also exhibit high transparency. These films can be used as materials for packaging foods, medical equipment and accessories, and the like.

U.S. Pat. No. 6,129,782 to Brodie teaches a means of inhibiting bacterial growth particularly on a coated substrate and further comprises a method of forming a substantially dry powder coating containing a biocide and applying the powder coating composition to form a coating on the substrate, the biocide being capable of retaining effective biocidal activity in the coating.

U.S. Pat. No. 5,487,412 to Matthews teaches a rigid, glass fiber airduct for conveying an airstream having an interior surface, adapted to be in contact with the airstream, which is coated with a polymer coating comprising an organic or inorganic biocide. The polymer coating has a dry solids content between 10 and 20 grams per square foot of duct board surface and retains its abrasion strength and puncture resistance whereby the interior surface of the airduct can be cleaned by conventional industrial or commercial cleaning procedures while in service without exposing glass fibers to the airstream.

U.S. Pat. No. 4,780,333 to Smith teaches a method of treating an air-contacted surface of an air conditioning system comprising the steps of: (a) introducing to the air passage an air-borne biocide in a biocidally effective amount; and (b) subsequently introducing into the air passage an air-borne biostat adapted to coat the surface with an air-driable, substantially water insoluble biostat coating, the biostat being introduced in an amount sufficient to coat the surface with a biostatically effective coating.

U.S. Pat. No. 5,201,119 to Mizuno teaches a heat exchanger made of aluminum which includes a plurality of tubes made of aluminum through which a fluid to be heat exchanged flows, the tubes having a metal surface of aluminum; fins made of aluminum arranged between the tubes for accelerating heat exchange between the fluid to be heat-exchanged and air, the fins having a metal surface of aluminum; a first protecting film of a chemical conversion coating formed on the metal surfaces of the tubes and fins and containing a metal component; and a second protecting film of an antimicrobial agent coating on the first protecting film, at least on the fins among the tubes and fins, the second protecting film having a chemical bond with the metal component of the first protecting film.

U.S. Pat. No. 5,066,328 to Zlotnik teaches an antimicrobial mixture of copper-8-quinolinolate mixed with a binder composition that imparts sufficient fluidity to the copper-8-quinolinolate to permit the mixture to be applied as liquid and to adhere to air passageways, preferably metal, fiberglass or plastic media, such as building heat, ventilation and air conditioning ductwork.

U.S. Pat. No. 3,591,328 to Szappanyos teaches a method of treating the air contacted and adjacent surfaces of air propelling devices of air conditioning and air treating equipment by applying thereto an admixture of a fungicide and an air driable solvent and having film-reinforcing ingredients therein to coat the surfaces and to dry thereon to form a fungus growth inhibiting coating thereon. The admixture is introduced into the air inlet of air conditioning or treating equipment while the air propelling mechanism is functioning.

Therefore, while certain advances have been made to address the problem of microbial growth in HVAC systems, there still exists a need for a solution which is cost-effective, easily implemented, and enjoys long-term- efficacy. The present invention addresses the above-described needs by providing a flexible film structure which can be easily and inexpensively affixed to the HVAC systems. In addition, the long term efficacy of the flexible film structure of the present invention is superior to those known in the art because the antimicrobial agent is incorporated in a polymer resin. The fact that the antimicrobial agent is incorporated in a polymer resin prevents the antimicrobial agent from being scraped, brushed, or washed away over time.

### SUMMARY OF THE INVENTION

The present invention relates to flexible film structures and methods of making said film structures. The flexible film structures of the present invention comprise an antimicrobial agent incorporated in a polymer resin or a polymer resin blend. The flexible film structures of the present invention may be single layer films comprising an antimicrobial agent incorporated in a polymer resin or a polymer resin blend. The flexible film structures may also be multiple layer films comprising a layer comprising an antimicrobial agent incorporated in a polymer resin or polymer resin blend and one or more polymer layers wherein said polymer layer or layers may comprise a polymer or a blend of polymer and wherein the layer or layers containing the antimicrobial agent may be the skin or outer layer or layers of the film structure. The flexible film may be produced by extrusion or coextrusion technology. The flexible film may optionally be bonded to a substrate wherein said substrate may be a mono polymer film, a multiple layer polymer film, foil or paper. The film structures of the present invention may be used in HVAC systems to retard, reduce, inhibit or eliminate microbial growth. The film structures of the present invention are subject to but not limited to compliance with Underwriters Laboratories certification and test protocol UL-181. Therefore, the film structures of the present invention must be able to withstand heating temperatures of about 265° F. and air conditioning temperatures of about 20° F. Specifically, the film structures of the present invention are designed but not limited to be affixed around the inside core of wiremold material of an air duct with the antimicrobial film layer exposed to the inside surface of the air duct by adhesion to the wire of the inner core of flexible ducting. When placed in this aforementioned position, the antimicrobial film comes in contact with the microbial matter which may be found in the circulated air or on the inside surface of the air duct itself.

The method of making the flexible film structures of the present invention includes extruding a polymer film layer comprising an antimicrobial agent incorporated in a polymer resin or resin blend. This extruded film may optionally be laminated to a substrate wherein said substrate can be a monolayer polymer film, a multiple layer polymer film, foil or paper. Another method of making the flexible film of the present invention includes coextruding the film layer comprising the antimicrobial agent incorporated in a polymer resin or resin blend with another polymer film layer, thereby affording a single step process for making a film comprising a layer having the antimicrobial agent incorporated in a polymer resin and another polymer layer. It is also contemplated that a film structure comprising a layer having antimicrobial agent incorporated in a polymer resin and two or more additional polymer layers may be made by a coextrusion process. These multiple layer films may also be laminated to a substrate wherein said substrate can be a mono-layer polymer film, a multiple layer polymer film, foil or paper.

It is an objective of the present invention to provide a cost-effective and easily implementable method for addressing microbial growth in HVAC systems, especially within flexible air ducts.

It is an objective of the present invention to provide a method for addressing microbial growth in HVAC systems comprising a material that is non-toxic, and has long-term efficacy and long-term stability (i.e., will not flake off or be washed off as with many liquid solution-applied antimicrobial applications).

It is an objective of the present invention to provide a flexible film comprising an antimicrobial agent incorporated in a polymer resin.

It is an objective of the present invention to provide a flexible film comprising an antimicrobial agent incorporated in a polymer resin wherein said film structure is bonded to a substrate and wherein said substrate may be a mono-polymer film, a multiple polymer film, foil, or paper.

It is an objective of the present invention to provide a flexible film comprising a layer having an antimicrobial agent incorporated in a polymer resin and one or more polymer layers wherein the layer containing the antimicrobial agent is the skin or outer layer of the film.

It is another objective of the present invention to provide a flexible film structure which can be easily attached to existing flexible air ducts of the HVAC system or air conveying systems/containers that pose a risk of microbial contaminants.

It is a further objective of the present invention to provide a method of preparing and installing the flexible film structure of the present invention that is effective both in cost and operation. Many liquid solution based antimicrobial application methods that are commercial today are sprayed onto the inside of the duct and many after the duct is manufactured. This prevailing method poses the risk of voids in application, is more costly, and risks flaking and deteriorating due to moisture exposure and flexing that may cause cracking in the liquid applied applications. The present invention herein described mitigates these risks related to current technology by improving the integrity, process and application of the antimicrobial materials.

It is a still further objective of the present invention to provide a flexible film structure which can be further enhanced with a flame retardant material for compliance with Underwriters Laboratories residential, commercial and industrial consumer flexible and HVAC air duct applications.

### DESCRIPTION OF THE DRAWINGS

FIG. 1 shows a front view of a complete flex duct.

FIG. 2 shows a close-up view of the wiremold inner core.

FIG. 3 shows a film structure of the present invention affixed to the wiremold inner core.

FIG. 4 shows a single layer film structure of the present invention.

FIG. 5 shows a two layer film structure of the present invention.

### DETAILED DESCRIPTION OF THE INVENTION

The present invention relates to a flexible film comprising an antimicrobial agent incorporated in a polymer resin or polymer resin blend. The flexible film of the present invention may be a single polymer layer or a multiple layer film comprising two or more layers wherein the layer containing the antimicrobial agent is the skin or outer layer of the film. A preferred embodiment of the present invention is a two layer polymer film comprising a layer containing the antimicrobial agent incorporated in a polymer resin or a polymer resin blend which is extrusion laminated to a second polymer layer wherein said second polymer layer may comprise a single polymer or a polymer blend and wherein the layer containing the antimicrobial agent is the skin or outer layer of the film. The films of the present invention may optionally further comprise a flame retardant material.

The flexible films of the present invention may optionally be bonded to a substrate wherein the substrate is a mono layer polymer film, a multiple layer polymer film, foil or paper. The flexible film of the present invention may be bonded to the various exemplified substrates by extrusion lamination, adhesive lamination or other technologies known to those in the art. It is understood that in cases wherein the flexible film of the present invention is bonded to any one of the above substrates the layer containing the antimicrobial agent is the skin or outer layer of the total film structure. It is also understood that the antimicrobial agent could initially be placed in an inner layer of a film structure of the present invention and migrate to the outer or skin layer of the structure.

The films of the present invention may be utilized in conjunction with flexible air ducts in order to retard, reduce, inhibit or eliminate microbial growth either in the air which is circulated in the duct itself or particles affixed to the inside surface of the air duct. The films of the present invention are affixed to the inside surface of the air duct with the antimicrobial film layer exposed to the inside surface of the air duct. The film structures of the present invention can be affixed to the air duct by gluing the film structure to the wiremold core of a flexible air duct. While gluing the film structures to the wiremold core of a flexible air duct has been exemplified, other methods are contemplated by this invention.

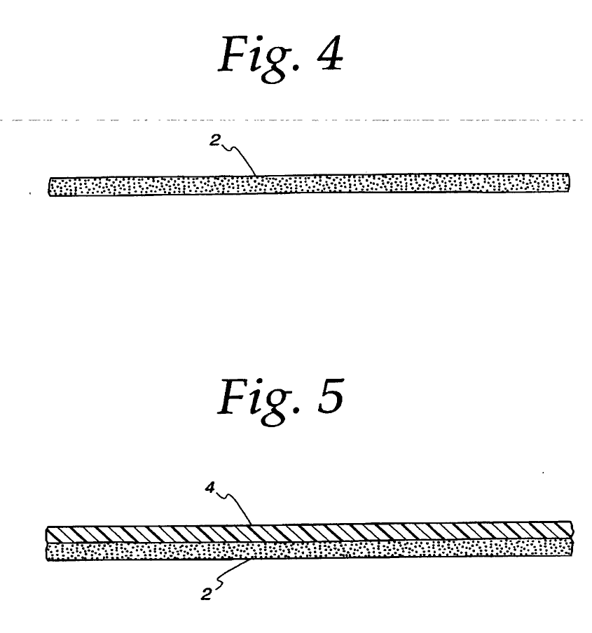

Methods of production include but are not limited to the extrusion of molten polymers in either monolayer blends (see FIG. 4) or coextrusion blends (see FIG. 5) whereby the antimicrobial agent is added to the polymer resin and solidified permanently into the cooled plastics in sheet form in thicknesses ranging from 0.25 mils to 5.0 mils. These sheets can later be cut to size and/or oriented in machine direction or cross machine direction or be used directly in sheet form for conversion into flexible ducting or HVAC materials. The sheeting of antimicrobial materials can also be extrusion laminated to another polymer film, foil or paper to add rigidity or other specific properties beyond the antimicrobial properties. This same antimicrobial sheeting can also be adhesive laminated to other polymer materials such as polyester, polypropylenes, and polyethylenes, foil or paper to also add rigidity or flame retardant properties.

The flexible film structure of the present invention is then supplied to a converter, who use the flexible film structures along with additional raw materials to spirally wind and glue the film structure to a spiral wire that forms the outer core of HVAC flexible ducting as a tube. The converter's process consists of taking strips of the flexible film of the present invention and adhesive gluing or heat bonding the materials to a spiral wire. The glue is typically enhanced with a flame retardant and or smoke suppressant in order to comply with Underwriters Laboratories certification UL-181 protocols. This spiral winding creates a tube whereby the entire duct is connected to air conditioning or heating or air conveyance systems and acts as the conduit for air to move from one originating location to a destination on using the most cost effective materials versus rigid ducting.

Polymers suitable for use in the present invention either as the polymer resin incorporating the antimicrobial agent or as a polymer of a mono- or multiple layer film are exemplified but not limited to olefin polymers or copolymers such as polyethylenes which can be further exemplified by low density polyethylene (LDPE), linear low density polyethylene (LLDPE), and high density polyethylene (HDPE); ethylene vinyl acetate copolymer (EVA); Metallocene polyethylene (mLLDPE) or polypropylene (CPP or OPP); ethylene-(meth)acrylic acid copolymer (EAA or EMA); polyamides such as poly(hexamethylene sebacamide) (nylon 6,10), poly(hexamethylene adipamide) (nylon 6,6) and poly epsilon caprolactan (nylon-6); polyesthers such as poly(ethylene terephthalate). Various combinations of the above materials can also be used in order to achieve heat stability in the film structures of the present invention so as to comply with Underwriters Laboratories certification protocols but the antimicrobial agent will function at all application temperatures and does not necessitate UL certification for industry use. When using EVA (ethylene vinyl acetate) and due to the low melting temperature of this resin the antimicrobial agent that has been added to the polymers is processed through an electron beam radiation to increase heat and thermal stability to levels necessary to pass Underwriters Laboratories certification in air ducting applications.

Particularly preferred polymers suitable for use in the present invention are characterized by nylons, polypropylenes and high density polyethylenes that are characterized by higher thermal stability in order to meet Underwriters Laboratories criteria for HVAC ducting components. Further preferred polymers for use in the present invention are exemplified by nylon-6 or nylon 6,6 wherein nylon-6 is further exemplified by Honeywell Q73 from Honeywell Industries; other preferred polymers are exemplified by high impact polypropylenes from Basel and fractional melt index high density polyethylenes which can be further exemplified by Dow Inspire from Dow Chemicals.

The film structures of the present invention may each comprise a single polymer layer or may comprise several polymer layers. Preferred film structures are produced by extrusion or coextrusion technology. Preferred structures having a single layer have a caliper of 0.25 mil to 5.00 mil. Multiple layer structures have a caliper of 0.40 mil to 5.00 mil for the entire film structure. If the film structure is multiple layer structure, the various layers of the structure can be the extrusion or adhesive laminated to lower cost substrates such as polyesters, copolymer or homopolymer polypropylenes, crosslinked ethylene vinyl acetate copolymer blends or high density polyethylenes.

While a number of polymers have been exemplified, it is to be understood that any polymer which meets the temperature requirement of the present invention either as an inherent property of the polymer itself or through irradiation would be suitable for use in the present invention.

A preferred embodiment of the present invention is a single layer film comprising an antimicrobial agent incorporated in a polymer resin. A particularly preferred embodiment is a film structure comprising 99% by volume of nylon-6 and 1% by volume of an antimicrobial agent wherein the antimicrobial agent can be exemplified by tributyl tin maleate.

Another preferred embodiment of the present invention is a two layer film comprising an antimicrobial agent incorporated in a polymer resin which is extrusion laminated to another polymer layer to form a film structure comprising 90% by volume of nylon-6 and 10% of a compound of 10% antimicrobial agent and 90% polymer resin wherein the antimicrobial agent is tributyl tin maleate and the polymer resin is nylon-6. Another further preferred embodiment of the present invention is a two layer film comprising 85% by volume of nylon-6 and 15% of a compound of 15% by volume antimicrobial agent and 85% polymer resin wherein the antimicrobial agent is tributyl tin maleate and the polymer resin is nylon-6.

The flexible films structure of the present invention may also be bonded to a substrate wherein said substrate can be a mono-layer polymer film, a multiple layer polymer film, foil or paper. Polymers suitable for a mono-layer polymer film substrate or a multiple layer film substrate can be exemplified by, but not limited to, polyesters, homopolymers or copolymers of polypropylenes, homopolymers or copolymers of polyethylenes such as high density polyethylene, and crosslinked ethylene vinyl acetate copolymers. Other substrates for use in the present invention can be exemplified by paper and foil. A paper substrate may also have to incorporate a fire retardant component in order to meet the temperature requirements of the present invention. A typical fire retardant material is Techmer PM1605E4 from Techmere PM which may be added to the paper or may be incorporated into any one of the polymer layers.

It is also contemplated that the film structures of the present invention may also be incorporated into other types of construction materials exemplified by, but not limited to, drywall, particle board, and ceiling tiles.

The flexible films of the present invention comprise an antimicrobial agent incorporated in a polymer resin or polymer resin blend. An antimicrobial agent is defined as a substance capable of retarding, reducing, inhibiting or eliminating microbial growth. The antimicrobial agent of the present invention is present in the polymer resin from about 0.025% to about 15% by volume percent with a preferred range being about 0.5% to 5% volume percentage and a most preferred range being about 1% to about 2% volume percentage.

### DETAILED DESCRIPTION OF DRAWINGS

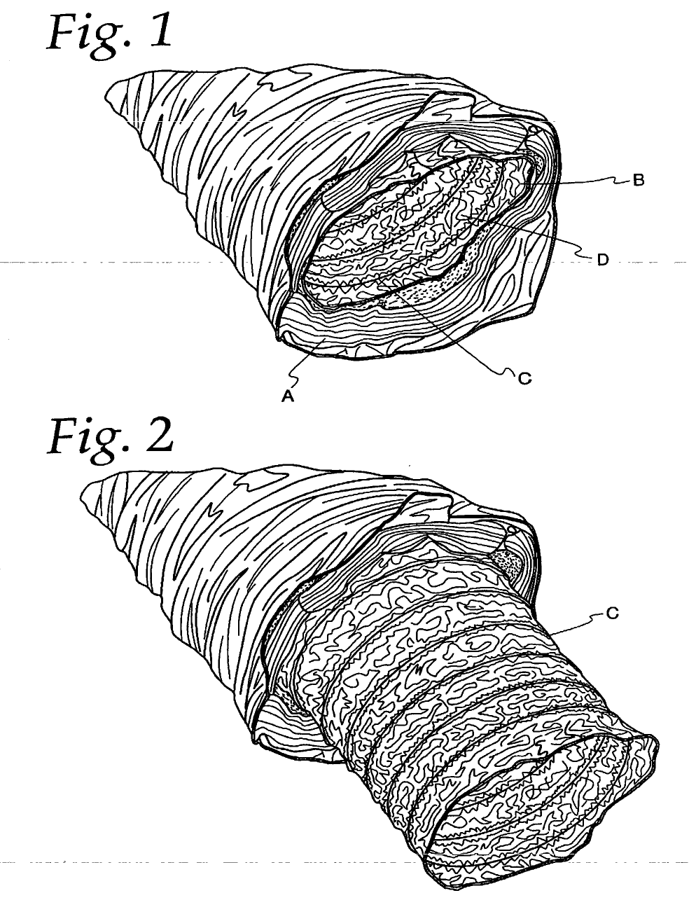

FIG. 1 shows a front view of a complete flex duct in which A is the insulation; B is the sleeve or tape wrapped around the insulation; C is the wiremolded inner core; and D is the film of the invention affixed to the wiremolded inner core.

FIG. 2 shows a close-up view of the fabricated wiremolded inner core C;

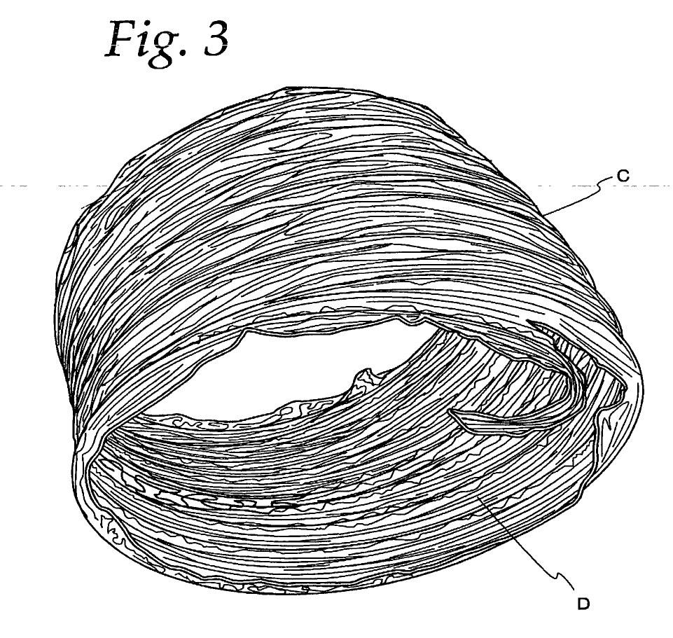

FIG. 3 shows a close-up view of the fabricated wiremolded inner core C with the film structure D of the present invention affixed to the wire.

FIG. 4 illustrates a film structure of the present invention comprising a single layer. The single layer 2 of FIG. 4 comprises an antimicrobial agent incorporated in a polymer resin or polymer resin blend.

FIG. 5 illustrates a multilayer film structure of the present invention comprising polymeric film layer bonded to an antimicrobial outer layer or skin layer, wherein an antimicrobial agent is incorporated in the polymer resin or polymer resin blend of layer 2. The film structure 1 of FIG. 5 may also comprise any number of other polymeric film layers as may be apparent to one having ordinary skill in the art. The film structure 1 of FIG. 5 may also be bonded to a substrate by adhesive lamination, extrusion lamination or other lamination technology apparent to those skilled in the art. Layer 2, which is the outer or skin layer of the film structure 1 may be made of an antimicrobial agent incorporated in a polymer resin or polymer resin blend. Antimicrobial agents suitable for use in layer 2 are exemplified but not limited to silver sodium hydrogen zirconium phosphate and tributyl tin maleate. Other antimicrobial agents suitable for use in the present invention are presented later. The antimicrobial agent is incorporated in a polymer resin or resin blend. Polymer resins suitable for use in this layer either independently or as blends are exemplified by poly epsilon caprolactam and polypropylene. Other polymer resins suitable for use in this layer are presented later. Layer 4 is a polymeric layer comprising a single polymer or a polymer blend which is extrusion laminated to layer 2 to form film structure 1 of FIG. 5. Polymers suitable for use in this layer are exemplified by but not limited to poly epsilon caprolactam polypropylene, poly(hexamethylene adipamide) and poly(hexamethylene sebacamide). Other polymers suitable for use in this layer are presented later. A typical film structure 1 of FIG. 5 may comprise from about 0.025% to about 15% by volume of the antimicrobial agent wherein the polymers of layer 2 may comprise from about 2% to about 25% of the entire film structure and layer 4 may comprise from about 98% to about 75% by volume.

Antimicrobial agents suitable for use in the present invention are exemplified by, but not limited to, the following agents:

| Antimicrobial Agent | Trade Name | Supplier |
|---|---|---|
| silver sodium | Alpha San ® RC 500 | Milliken Chemical, |
| hydrogen zirconium | B8000 or B5000 | Spartanburg, SC or Ciba |
| phosphate | | Geigy |
| Tributyl tin maleate | Ultra Fresh ® DM-50 | Thomson Research Asso- |
| | | ciates, Ontario, Canada |
| octyl isothiazolinone | Ultra Fresh ® DM-25 | Thomson Research Asso- |
| | | ciates, Ontario, Canada |
| Diiodomethyl | Ultra Fresh ® DM-95 | Thomson Research Asso- |
| p-tolyl sulfone | | ciates, Ontario, Canada |
| 2,4,4,-trichloro-2- | Triclosan | Ciba Geigy |
| hydroxydiphenyether | | |

The flexible film structures of the present invention are capable of retarding, reducing, inhibiting or eliminating the microorganismic growth. Microorganisms whose growth can be eliminated or controlled by the film structures of the present invention are exemplified but not limited to the following organisms:

Gram Positive Bacteria Exemplified by the Following:

Bacillus cereus

Bacillus mycoides

Bacillus subtilis

Brevibacterium ammoniagenes

Brevibacterium epidermidis

Corynebacterium pseudodiptheriticum

Nocardia asteroides

Staphylococcus aureus (& MRSA)

Streptoverticillium reticulum

Gram Negative Bacteria Exemplified by the Following:

Acinetobacter calcoaceticus

Enterobacter aerogenes

Enterobacter cloacae

Escherichia coli

Klebsiella pneumoniae

Morganella morganii

Proteus mirabilis

Proteus vulgaris

Pseudomonas aeruginosa

Salmonella cholersaesuis

Fungi Exemplified by the Following:

Alternaria altemata

Aspergillus niger

Aureobasidium pullutons

Candida albicans

Chaetomium globosum

Curvularia genticulata

Epidermophyron floccosum

Fusarium oxysporum

Gloeophyllum trabeum

Lentinus lepideus

Mucor racemosus

Paecilomyces vroti

Penicillium funiculosum

Penicillium variabile

Rhizopus spp.

Schizophyllum commune

Serpula lacrymans

Stachybotrys chartarum

Trichoderma viride

Trichophyton mentagrophytes

Trichophyton rubrum

The invention is illustrated by the following non-limiting examples.

### EXAMPLES

Example 1 includes a single layer film. The film comprises 1% by volume of tributyl tin maleate and 99% by volume of nylon-6. The single layer film is produced by extrusion technology.

Example 2 includes a two-layer film comprising a first layer of tributyl tin maleate in nylon-6 and a second layer of nylon-6. The resultant film is produced by coextrusion technology comprising 90% by volume of nylon-6 - Floneywell Q73 and 10% of a compound of 10% tributyl tin maleate and 90% by volume of nylon-6—Honeywell Q73.

Example 3 includes a two-layer film comprising a first layer of tributyl tin maleate and nylon-6—Honeywell Q73 and a second layer ol nylon-6—Honeywell Q73. The resultant film structure, which is produced by coextrusion technology, consists of 85% by volume of nylon-6 and 15% by volume of a compound of 15% by volume of tributyl tin maleate and 85% by volume of nylon-6—Honeywell Q73.

Example 4 includes a two-layer film comprising a first layer of silver sodium hydrogen and nylon-6 and a second layer of nylon-6. The resultant film which is produced by coextrusion technology consists of 95% by volume of nylon-6 and 5% by volume of a compound of 5% by volume of silver sodium hydrogen and 95% by volume of nylon-6.

Example 5 includes a two-layer film comprising a first layer of silver sodium hydrogen and nylon-6 and a second layer of nylon-6. The resultant film which is produced by coextrusion technology consists of 97% by volume of nylon-6 and 3% by volume of a compound of 3% by volume of silver sodium hydrogen and 97% by volume of nylon-6.

Example 6 includes a two-layer film comprising a first layer of tributyl tin maleate and polypropylene and a second layer of nylon-6—Honeywell Q73. The resultant film which is produced by coextrusion technology consists of 95% by volume of nylon-6 and 5% by volume of a compound of 5% by volume of tributyl tin maleate and 95% by volume of polypropylene.

Example 7 includes a two-layer film comprising a first layer of tributyl tin maleate and polypropylene and a second layer of nylon-6—Honeywell Q73. The resultant film which is produced by coextrusion technology consists of 90% by volume of nylon-6—Honeywell Q73 and 10% by volume of a compound of 10% by volume of tributyl tin maleate and 90% by volume of polypropylene.

Example 8—The film of example 8 is produced in the same maimer as example 7, except polyethylene is substituted for the polypropylene.

Example 9—The film of example 9 is produced in the same manner as example 6 except polyethylene is substituted for the polypropylene.

The films of examples 4, 5, 6, 7, 8 and 9 were tested using procedures from the American Association of Textile Chemists and Colorists. Test Method 30—1998—“Antifungal, Assessment Textile Materials: Mildew and Rot Resistance of Textile Materials” was used to determine antifungal activity. Test Method 147—1998 “Antibacterial Activity Assessment of Textile Materials Parallel Streak Method” was used to determine antibacterial activity. In the above-described test, a film of the present invention is substituted for the textile material or cloth of the test. The results are shown below in Table I, II and III.

TABLE 1

| | | | SURFACE |
|---|---|---|---|
| EXAMPLE | | GROWTH-FREE | INHIBITION |
| NO. | | ZONE (MM)* | (%)** |
| 4 | -back | 0 | 100 |
| | | 0 | 90 |
| 5 | -antimicrobial side | 0 | 90 |
| | -back | 0 | 90 |
| 6 | -antimicrobial side | 0 | 100 |
| | -back | 0 | 90 |
| 7 | -antimicrobial side | 0 | 100 |
| | -back | 0 | 100 |
| 8 | -antimicrobial side | 1 | 100 |
| | -back | 3 | 90* |
| 9 | -antimicrobial side | 0 | 100 |
| | -back | 0 | 100 |
| Control | -back | 0 | 90 |
| | | 0 | 90 |
| Control | -antimicrobial side | 0 | 90 |
| | -back | 0 | 90 |
| Control | -antimicrobial side | 0 | 90 |
| | -back | 0 | 90 |

Results for Table 1

Both sides of Examples 7 and 9, and the antimicrobial side of Examples 4, 6 and 8 remained free of growth from the S. chartarum test organism. The back of Example 8 supported growth of the test organism, however a growth-free zone was also produced. The remaining examples supported a trace amount of fungal growth. The controls contain no active ingredients nor is any active ingredient on the backside of the controls.

TABLE 2

| | | | SURFACE |
|---|---|---|---|
| EXAMPLE | | GROWTH-FREE | INHIBITION |
| NO. | | ZONE (MM)* | (%)** |
| 4 | -antimicrobial side | 0 | 90 |
| | -back | 0 | 90 |
| 5 | -antimicrobial side | 0 | 90 |
| | -back | 0 | 90 |
| 6 | -antimicrobial side | 0 | 100 |
| | -back | 0 | 100 |
| 7 | -antimicrobial side | 1 | 100 |
| | -back | 1 | 100 |
| 8 | -antimicrobial side | 1 | 100 |
| | -back | 5 | 100 |
| 9 | -antimicrobial side | 1 | 100 |
| | -back | 1 | 100 |
| Control | -antimicrobial side | 0 | 100 |
| | -back | 0 | 90 |
| Control | -antimicrobial side | 0 | 100 |
| | -back | 0 | 90 |
| Control | -antimicrobial side | 0 | 100 |
| | -back | 0 | 90 |

Results for Table 2

Both sides of Examples 7, 8 and 9 demonstrated good activity against the A. niger test organism. Both sides of Example 6 and the antimicrobial side of the control of all three remained free of fungal growth. Both sides of Example 4 and 5, and the back of all three controls supported a trace amount of fungal growth. The control samples contain no active ingredients nor is any active ingredient contained on the backside of any samples.

TABLE 3

| | | | SURFACE |
|---|---|---|---|
| EXAMPLE | | GROWTH-FREE | INHIBITION |
| NO. | | ZONE (MM)* | (%)** |
| 4 | -antimicrobial side | 0 | 0 |
| | -back | 0 | 0 |
| 5 | -antimicrobial side | 0 | 0 |
| | -back | 0 | 0 |
| 6 | -antimicrobial side | 2 | 100 |
| | -back | 4 | 0* |
| 7 | -antimicrobial side | 3 | 100 |
| | -back | 7 | 0* |
| 8 | -antimicrobial side | 4 | 100 |
| | -back | 10 | 100 |
| 9 | -antimicrobial side | 2 | 100 |
| | -back | 5 | 0* |
| Control | -antimicrobial side | 0 | 0 |
| | -back | 0 | 0 |
| Control | -antimicrobial side | 0 | 0 |
| | -back | 0 | 0 |
| Control | -antimicrobial side | 0 | 0 |
| | -back | 0 | 0 |

Results for Example 3

Both sides of Example 8 and the antimicrobial side of Examples 6, 7 and 9 demonstrated good activity against the S. aureus test organism. The back of Examples 6, 7 and 9 also produced growth-free zones, however bacterial growth was also observed beneath the sample. Both sides of Examples 4, 5 and all three controls failed to show antibacterial activity. The control samples contain no active ingredients nor is any active ingredient present on the backside of any samples.

The antimicrobial agent is generally in a powder form. The antimicrobial agent (powder) is primarily dispensed in a polymer resin or resin blend. The antimicrobial active ingredients could be added directly in the extrusion manufacturing process but we have discovered that pre-compounding of the antimicrobial agent with a resin improves machinability and processability as well as degree of accuracy of the concentration when small percentages are being blended.

While the invention of the present invention has been described in conjunction with its use in flexible air ducts, it is certainly envisioned that the present invention may also be used in other types of air ducts or other components of the HVAC system as well as other construction materials where the control or elimination microbial growth may be necessary.

What is claimed is:

1. A flexible air duct comprising:
(a) a flexible film wherein said flexible film comprises an antimicrobial agent incorporated in a polymer resin or a polymer resin blend; and
(b) a wiremold material wherein said flexible film is affixed to said wiremold material.

2. The flexible air duct according to claim 1 wherein the flexible film further comprises one or more polymer layers.

3. The flexible air duct according to claim 2 wherein each polymer layer independently comprises a polymer or a blend of polymers.

4. The flexible air duct according to claim 1 wherein the polymer is selected from the group consisting of low density polyethylenes, linear low density polyethylenes, high density polyethylenes, ethylene vinyl acetate copolymer, polypropylene, poly(hexamethylene sebacamide), poly(hexamethylene adipamide) and poly epsilon caprolactam.

5. The flexible air duct according to claim 1 wherein the antimicrobial agent is selected from the group consisting of silver sodium hydrogen zirconium phosphate, tributyl tin maleate, octyl isothiazolinone, diiodomethyl p-totyl sulfone and 2,4,4-trichloro-2-hydroxydiphenyester.

6. The flexible air duct according to claim 4 wherein the polymer is poly epsilon caprolactam.

7. The flexible air duct according to claim 4 wherein the polymer is polypropylene.

8. The flexible air duct according to claim 5 wherein the antimicrobial agent is silver sodium hydrogen zirconium phosphate.

9. The flexible air duct according to claim 1 wherein the antimicrobial agent is tributyl tin maleate.

10. The flexible air duct according to claim 1 wherein the flexible film comprises 90% by volume of poly epsilon caprolactam and 10% by volume of a compound of 10% by volume tributyl tin maleate and 90% by volume of poly epsilon caprolactam.

11. The flexible air duct according to claim 1 wherein the flexible film comprises 95% by volume of poly epsilon caprolactam and 5% by volume of a compound of 5% by volume of silver sodium hydrogen zirconium phosphate and 95% by volume of poly epsilon caprolactam.

12. The flexible air duct according to claim 1 wherein the flexible film comprises 97% by volume of poly epsilon caprolactam and 3% by volume of a compound of 3% by volume of silver sodium hydrogen zirconium phosphate and 97% by volume of poly epsilon caprolactam.

13. The flexible air duct according to claim 1 wherein the antimicrobial agent is present in the flexible film from about 0.25% by volume to about 15% by volume.

14. The flexible air duct according to claim 13 wherein the antimicrobial agent is present in the flexible film from about 1% by volume to about 3% by volume.

15. The flexible air duct according to claim 1 wherein the flexible film further comprises a fire retardant material.

16. The flexible air duct according to claim 1 wherein the flexible film is affixed to the wiremold material by gluing said flexible film to said wiremold material.

17. A method of making a flexible air duct comprising the following steps:
(a) providing a flexible film wherein said film comprises an antimicrobial agent incorporated in a polymer resin or polymer resin blend; and
(b) affixing said film to the wiremold material of said flexible air duct.

18. The method of claim 17 wherein the flexible film is formed by coextrusion technology.

19. The method of claim 17 wherein the polymer is selected from the group consisting of low density polyethylenes, linear low density polyethylenes, high density polyethylenes, ethylene vinyl acetate copolymer, polypropylene, poly(hexamethylene sebacamide), poly(hexamethylene adipamide) and poly epsilon caprolactam.

20. The method of claim 19 wherein the polymer is poly epsilon caprolactam.

21. The method of claim 19 wherein the polymer is polypropylene.

22. The method of claim 17 wherein the antimicrobial agent is selected from the group consisting of silver sodium hydrogen zirconium phosphate, tributyl tin maleate, octyl isothiazolinone, diiodomethyl p-totyl sulfone and 2,4,4-trichloro-2-hydroxydiphenyester.

23. The method of claim 22 wherein the antimicrobial agent is silver sodium hydrogen zirconium phosphate.

24. The method of claim 22 wherein the antimicrobial agent is tributyl tin maleate.

25. A flexible air duct made by the method of claim 17.
